(19) United States
(12) Patent Application Publication
(10) Pub. No.: US 2014/0041159 A1
(43) Pub. Date: Feb. 13, 2014

(54) POLYAMIDE COMPOSITION, CABLE TIE MADE THEREOF AND ITS MANUFACTURING METHOD

(71) Applicants: Lee Zhao, Shanghai (CN); Jiayu William Yuan, Shanghai (CN); Jianfeng Huang, Shanghai (CN)

(72) Inventors: Lee Zhao, Shanghai (CN); Jiayu William Yuan, Shanghai (CN); Jianfeng Huang, Shanghai (CN)

(73) Assignee: HONEYWELL INTERNATIONAL INC, Morristown, NJ (US)

(21) Appl. No.: 13/805,942

(22) PCT Filed: Sep. 3, 2010
(86) PCT No.: PCT/CN10/01338

§ 371 Date: Apr. 23, 2013

(51) Int. Cl. C08L 77/00; B65D 63/10; B29C 45/00

(52) U.S. Cl. CPC C08L 77/00; B29C 45/0001; B65D 63/1027
USPC 24/16 PB; 264/328.16; 524/539; 524/227

(57) ABSTRACT

A polyamide composition formed from a low viscosity polyamide-6 and a nucleating agent including an organic material and an inorganic metallic material is provided. Suitable organic materials include organic polymers. Suitable inorganic metallic materials include metal oxides and silicates. Cable ties and methods of molding cable ties from the polyamide composition are also provided.

### FIELD OF THE INVENTION

The present invention is generally related to the field of polyamides. In particular, the present invention is related to polyamide compositions formed from polyamide-6 and a nucleating agent, and methods of making articles from such polyamide compositions.

### DESCRIPTION OF RELATED ART

Stable low molecular weight and low viscosity polyamides, such as polyamide-6 and polyamide-66, are used for a variety applications including for engineering plastics and textile applications. In the area of engineering plastics, these polyamides may be used in applications utilizing injection molding techniques.

The relative properties and performance characteristics of polyamide-6 and polyamide-66 make each polymer more suitable for certain applications. For example, cable ties used in the auto and electronics industries have historically been manufactured from polyamide-66 using an injection molding process to meet industry performance requirements. Although polyamide-6 offers certain benefits over polyamide-66 for manufacturing cable ties, issues with poor mold release, sprue breakage and brittleness have impeded the manufacture of cable ties from polyamide-6.

### SUMMARY OF THE INVENTION

One embodiment of the invention is a cable tie comprising an elongated polymer body formed from a polyamide composition. The polyamide composition includes a polyamide-6 material and a nucleating agent. The nucleating agent includes at least one inorganic metallic material, and at least one organic material. The polyamide composition may also include an optional lubricating agent.

Another embodiment is a method for forming a cable tie from a polyamide composition comprising at least one polyamide-6 material and at least one nucleating agent, the nucleating agent comprising at least one inorganic metallic material and at least one organic material. The polyamide composition is melted, injected into a mold, and cooled to form the cable tie. The cable tie is then released from the mold.

A further embodiment of the invention is a polyamide composition including a low viscosity polyamide-6 having a viscosity of less than 42 FAV, less than about 2.0 wt % of a nucleating agent and a lubricating agent. The nucleating agent includes at least about 50 wt % organic polymer and less than about 50 wt % inorganic metallic material.

Another embodiment is a method of forming a polyamide composition, in which a polyamide-6 composition is combined with a nucleating agent and optionally a lubricating agent. The nucleating agent includes an organic polymer and an inorganic metallic material. The components may be pre-blended, compounded, pelletized and packaged.

### BRIEF DESCRIPTION OF THE FIGURES

FIG. 1 is a flowchart illustrating a method of forming a polyamide composition according to embodiments of the present invention.

FIG. 2 is a flowchart illustrating a method of forming a cable tie according to embodiments of the present invention.

FIG. 3 shows a cable tie manufactured according to embodiments of the present invention.

### DETAILED DESCRIPTION

The present invention relates to polyamide compositions useful for a variety of applications including for the manufacture of cable ties by injection molding processes. In one embodiment, the polyamide composition includes at least one polyamide-6 material, at least one nucleating agent and at least one optional lubricant.

Suitable polyamide-6 materials are generally formed by reacting caprolactam and aminocaproic acid under temperature conditions suitable to initiate polymerization. Different polyamide-6 materials can be produced by changing the reaction time and/or temperature, by the inclusion of catalysts and by forming various end groups on the polyamide-6 material. Examples of commercially available polyamide-6 materials include Aegis® brand polyamide-6 products available from Honeywell International Inc. Specific examples of these products are sold under the brand designations H35ZI, H8202NLB, H35L, H50LN and H50L. The polyamide-6 may constitute at least about 90 wt % of the polyamide composition, more particularly, at least about 95 wt % of the polyamide composition. In one embodiment, the polyamide-6 may have a low viscosity, for example, less than about 52 FAV, more particularly, between about 25 and about 42 FAV, and even more particularly, between about 30 FAV and 42 FAV.

Suitable nucleating agents include mixtures of organic and inorganic components. Examples of suitable organic materials include organic salts such as carboxylic acid salts, amides such as arylamides, and organic polymers. Various polyamide materials other than polyamide-6 may be particularly suitable. In particular polyamides having a ratio of carbon atoms to amide groups of less than 5:1, more particularly, less than 3:1, even more particularly, no more than 2:1. An exemplary polyamide is polyamide-22.

Examples of inorganic materials suitable for use in the nucleating agent include inorganic metallic material. Suitable inorganic metallic materials include metal oxides and metal silicates. Particularly suitable inorganic metallic materials include alumina silicate aluminum oxide and silicon dioxide. Other suitable inorganic materials include talc, mica, kaolin, asbestos, alumina, silica, silver bromide, graphite, molybdenum disulfide, lithium fluoride, sodium phenylphosphinate, sodium isobutylphosphinate, magnesium oxide, mecuric bromide, mercuric chloride, cadmium acetate, lead acetate, silver chloride and the like.

Particularly suitable combinations of organic and inorganic materials include polyamides having a ratio of carbon atoms to amide groups of less than 5:1 (such as polyamide 2.2) and metal silicates. In one embodiment, the organic component constitutes greater than 50 wt % of the nucleating agent, more particularly, between about 60 and about 95 wt %, even more particularly, between about 75 and 90 wt %. The inorganic component constitutes less than 50 wt % of the nucleating agent, more particularly between about 5 and about 40 wt %, even more particularly, between about 5 and about 15 wt %. An exemplary commercially available nucleating agent is P22, a 90 wt % polyamide-2.2/10% alumina silicate material manufactured by Brueggemann Chemical. Additional organic and/or inorganic nucleating agents such as talc or silicon dioxide may be utilized in combination with the organic/inorganic nucleating agent described above. However, in one embodiment, the polyamide composition is free or substantially free of additional nucleating agents such as talc or silicone dioxide. The nucleating agent may constitute less than about 5.0 wt % of the polyamide composition, more particularly, less than about 1.0 wt %, and even more particularly, less than about 0.5 wt % of the polyamide composition.

A variety of lubricating agents may be suitable for use with embodiments of the present invention. Examples of suitable lubricating agents include stearamides such as ethylene-bis-stearamide, stearates such as zinc stearate, magnesium stearate, calcium stearate, and sodium stearate, polysiloxanes such as polydimethylsiloxane, polyolefins, and ethylenevinylacetate copolymers. Particularly suitable additives include zinc stearate and/or ethylene-bis-stearamide. The lubricating agent may constitute less than 5 wt % of the polyamide composition, more particularly, less than 2 wt % of the polyamide composition.

The polyamide composition may further include a variety of optional additives. Exemplary additives include, but are not limited to: antioxidants, thermal stabilizers, anti-weathering agents, mold releasing agents, pigments, dyes, plasticizers, antistatic agents, flame retardants, glass fillers, mineral fillers and impact modifiers. The polyamide composition may also include a fibrous or particulate filler, which functions to increase the modulus and stiffness of the composition.

Additionally, the polyamide composition may be blended with one or more polyamide-66 compositions if desired. In one embodiment, such a blended composition includes up to about 50 wt % of a polyamide-66 material.

The polyamide composition may be formed by conventional procedures. In one embodiment, the various raw materials are blended together. Appropriate blending techniques include melt extrusion, batch melting and the like. In one useful procedure, the blending procedure can be carried out at elevated temperatures above the melting point of the polymer and the nucleating agent either preformed, as individual components of the agent separately, or as a combination of the components in a suitable form such as granules, pellets and powders added to the melt with vigorous stirring. Alternatively, all or a portion of the various components of the nucleating agent can be masterbatched or preblended with the polyamide in the melt, and this premixed or masterbatch may be added to the polyamide in the melt in amounts sufficient to provide the desired amount of nucleating agent in the polyamide product. Stirring is continued until a homogeneous composition is formed. Blending temperatures and blending pressures, and the order of addition of the various components may be varied as desired provided that a substantially homogeneous composition results. The blending procedure can be carried out at elevated temperatures, in which case the polymer component is melted and the solid nucleating agent is admixed therewith by vigorously stirring the melt. Similarly, the various solid components can be granulated, and the granulated components mixed dry in a suitable blender, or for example, a Banbury mixer, as uniformly as possible, then melted in an extruder and extruded with cooling.

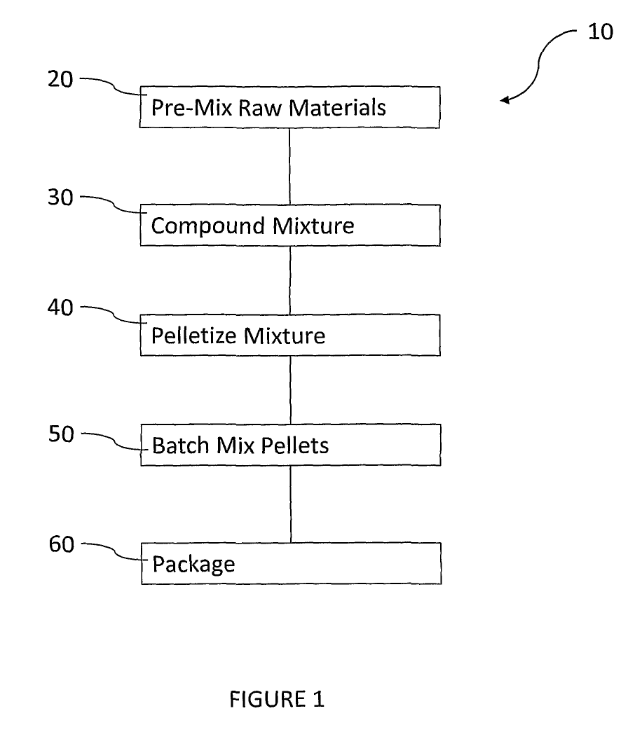

FIG. 1 illustrates a method 10 of forming a polyamide composition according to embodiments of the present invention. A polyamide mixture is formed by blending the polyamide material, the nucleating agent and the optional lubricating agent (block 20). The mixture is then compounded (block 30) and pelletized (block 40). The pellets are then batch mixed (block 50) and packaged (block 60) in a desired form for future use.

The resulting polyamide composition may be utilized to manufacture a variety of molded articles, fibers and films. Suitable molding techniques include injection molding, melt spinning, casting and extruding. In a particular embodiment, the polyamide composition may be used to manufacture electronic cable ties by injection molding techniques.

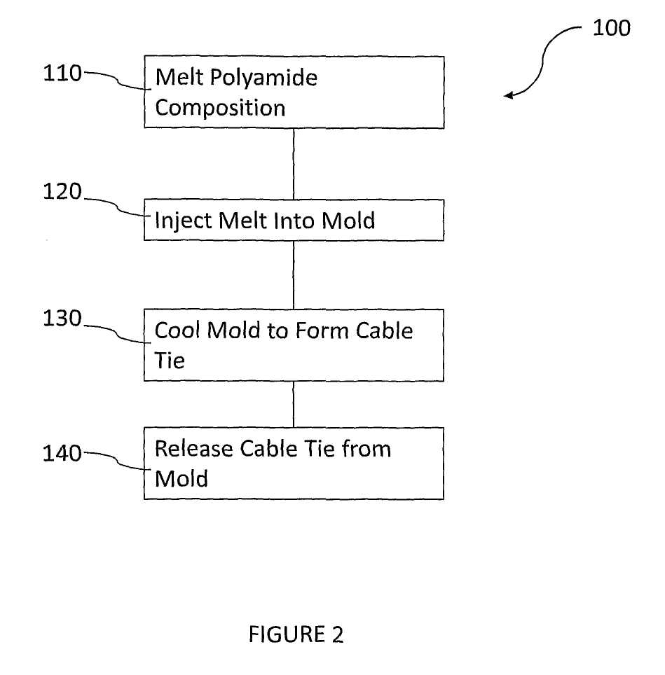

FIG. 2 illustrates a method 100 of forming cable ties according to embodiments of the present invention. A polyamide composition as described above is melted at a suitable temperature, for example between about 250° and 300° C. (block 110). The composition is then injected into a suitable mold at an injection pressure that is preferably below about 1000 kgf/cm² (block 120). The mold is cooled to solidify the polyamide composition in the form of a cable tie (block 130). The cable tie is then released from the mold (block 140).

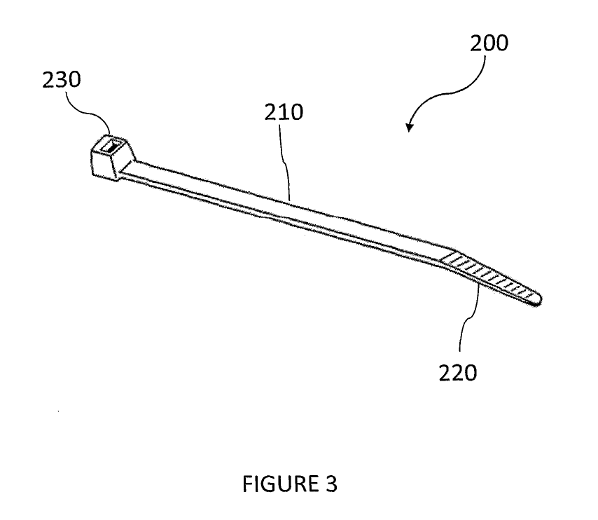

FIG. 3 shows an exemplary cable tie 200 according to one embodiment of the present invention. The cable tie 200 includes an elongate body 210, gear teeth 220 and a ratchet 230. In use, the cable tie 200 is wrapped around an object or objects, and the teeth 220 are inserted into the ratchet 230. The ratchet 230 includes a locking mechanism that interfaces with individual gear teeth. Of course, a variety of different cable tie configurations can be manufactured using the polyamide compositions of the present invention.

As set forth in the examples below, cable ties formed from the polyamide compositions of the present invention exhibit improved crystallinity, lower injection pressure, reduced mold sticking and sprue breakage and/or lower brittleness compared to both conventional polyamide-6 and polyamide-66 compositions. As such the polyamide compositions of the present invention are a viable substitute for polyamide-66 for a variety of applications including for forming cable ties.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

The compositions of Examples 1-2 and Comparative Examples A-B set forth in Table 1 below were master-batched by tumble blending the ingredients, and feeding the tumbled ingredients into the throat of a twin screw extruder (lab size 30 mm diameters) utilizing standard lab practices. H35ZI and H8202NLB are polyamide-6 compositions available from Honeywell International Inc. EBS stands for N/N′-ethylene bis-stearamide, a lubricating agent. P22 is a nucleating agent available from Bruggemann Chemical that constitutes a 90 wt % polyamide-2.2/10% alumina silicate mixture.

TABLE 1

| Component | H35ZI | H8202NLB | P22 | Zinc Stearate | EBS | Talc |
|---|---|---|---|---|---|---|
| Example | | | | | | |
| 1 | 98.73 | | 0.2 | 0.97 | 0.1 | |
| 2 | | 98.73 | 0.2 | 0.97 | 0.1 | |
| Comp. | | | | | | |
| Example | | | | | | |
| A | 98.93 | | | 0.97 | 0.1 | |
| B | 98.33 | | | 0.97 | 0.1 | 0.6 |

The compositions of Examples 3-4 and Comparative Examples C-N are set forth in Table 2 below. Examples 3-4 are blends of Example 1 set forth above and 101 L, a polyamide-66 composition available from Dupont. Comparative Examples C-N represent commercially available polyamide compositions and blends of commercially available polyamide compositions. H50LN, H50L and H35ZI are each polyamide-6 compositions available from Honeywell International Inc. A205F is a commercially available polyamide-66 sold by Rhodia. 21SPC is a commercially available polyamide-66 resin sold by Vydyne. 160ER is a commercially available polyamide-6 resin sold by Kopla. 1013B is a commercially available polyamide-6 composition sold by UBE Engineering Plastics. B3S is a commercially available polyamide-6 composition sold by BASF. B30s is a commercially available polyamide-6 composition sold by Lanxess.

TABLE 2

| Component | Ex. 1 | H50LN | H50L | H35ZI | A205F | 101L | 21SPC | 160ER | 1013B | B3S | B30s |
|---|---|---|---|---|---|---|---|---|---|---|---|
| Example | | | | | | | | | | | |
| 3 | 80 | | | | | 20 | | | | | |
| 4 | 50 | | | | | 50 | | | | | |
| Comparative | | | | | | | | | | | |
| Example | | | | | | | | | | | |
| C | | 100 | | | | | | | | | |
| D | | | 100 | | | | | | | | |
| E | | | | | 100 | | | | | | |
| F | | | | | | 100 | | | | | |
| G | | | | | | | 100 | | | | |
| H | | | | | | | | 100 | | | |
| I | | | | | | | 90 | | 10 | | |
| J | | | | | 90 | | | | 10 | | |
| K | | | | 10 | | | 90 | | | | |
| L | | | | 10 | 90 | | | | | | |
| M | | | | | | | | | | 100 | |
| N | | | | | | | | | | | 100 |

### Crystallization Characteristics

The crystallization characteristics of Example 1 were compared with Comparative Examples C-H, which represent various commercially available polyamide-6 and polyamide-66 compositions. The crystallization characteristics of each material was measured by differential scanning colorimetry (DSC). The DSC experiments were carried out using a DSC Q100 system according to standardized procedures. The sample was heated from 25° C. to 280° C. at a rate of 10° C./min. The 280° C. temperature was maintained for 2 minutes and the sample was then cooled back to 25° C. at a rate of 10° C./min. The melting temperature (Tm), crystallization temperature (TC) and percent crystallinity of each sample was measured. The results are set forth in Table 3 below.

TABLE 3

| | Tm (° C.) | Tc (° C.) | Crystallinity (%) |
|---|---|---|---|
| Example | | | |
| 1 | 223.37 | 192.73 | 26.3 |
| Comp Examples | | | |
| C | 223.06 | 193.6 | 23.7 |
| D | 222.32 | 188.62 | 26.3 |
| E | 262.6 | 234.95 | 33.0 |
| F | 263.16 | 211.08 | 29.9 |
| G | 262.98 | 219.51 | 32.1 |
| H | 222.07 | 162.75 | 24.4 |

The foregoing indicates that that Example 1, which includes an organic/inorganic nucleating agent according to embodiments of the present inventions, possesses a crystallization temperature and crystallinity lower than conventional polyamide-66 resins and similar to conventional polyamide-6 resins.

The non-isothermal crystallization rate was determined for Example 1 and Comparative Examples C, D and G according to standardized procedures. Each sample was heated from 25° C. to 280° C. at a rate of 50 Kelvin/min. The 280° C. temperature was maintained for 2 minutes and the samples were then cooled back to 25° C. at varying rates of 2.5 K/min, 5 K/min, 7.5 K, min, 10 K/min and 12.5 K/min. The results are set forth in Table 4.

TABLE 4

Example

| | 1 | C | D | G |
|---|---|---|---|---|
| X(t), % | F(T) | F(T) | F(T) | F(T) |
| 20 | 3.02981 | 6.397453 | 3.436316 | 3.53142 |
| 40 | 4.35925 | 8.268888 | 4.548511 | 4.702997 |
| 60 | 6.056306 | 10.55289 | 6.065397 | 6.177416 |
| 80 | 9.657164 | 15.46841 | 9.974182 | 11.22227 |
| 90 | 15.19703 | 23.13855 | 16.75505 | 18.86484 |

The results set forth in Table 4 indicate that Example 1 has a lower cooling rate (“F(T)”) to achieve a defined degree of crystallinity at a particular unit time (“X(t)”). See Qiao X Y, Wang X H, Zhao X J, Mo Z S, Zhang H F (2000) Synthetic Met 113: 1 The lower value F(T) value indicates a faster crystallization rate.

### Injection Molding Characteristics

The injection molding characteristics of Example 1 were then compared to various Comparative Examples, which represent commercially available polyamide-66 compositions. Table 5 below provides injection molding processability data for each Example. The injection molding apparatus used for the tests was a SE100DU-C250 produced by Sumitomo Heavy Industries, LTD. Samples were injection molded at the temperature indicated below into a cable tie mold having a maintained mold temperature of 90° C. The mold was allowed to cool for 3 seconds and the cable tie was then released from the mold. Injection pressure was measured via a pressure sensor. Mold release was measured according to a 0-5 scale. A zero score meant that the cable tie stuck tightly in the mold and a 5 score meant that the cable tie fell from the mold without additional processing steps. A score of four or higher is considered to be suitable. Buckle strength was measured by an Instron-5567 instrument available from Instron Corp., at 25° C., 50% relative humidity and a tensile speed of 50 mm/min.

TABLE 5

| | Molding Temp | | | | | | | | |
|---|---|---|---|---|---|---|---|---|---|
| | 285° C. | | 305° C. | | | | | | |
| Example | 1 | F | G | E | F | I | J | K | L |
| Injection | 900 | 1700 | 1200 | 1150 | 1350 | 1150 | 1200 | 1200 | 1200 |
| pressure | | | | | | | | | |
| (kgf/cm²) | | | | | | | | | |
| Mold release | 4.5 | 5 | 5 | 5 | 3 | 3.5 | 4 | 5 | 4 |
| Buckle strength | 34.04 | 39.18 | 41.41 | 46.48 | 40.2 | 37.97 | 41.33 | 39.99 | 37.66 |
| (conditioned) | | | | | | | | | |

The results set forth in Table 5 demonstrate that Example 1 has injection molding characteristics that are as good or better than polyamide-66 compositions. In particular, Example 1 achieved a lower processing temperature and injection pressure than the Comparative Examples, while still possessing suitable mold release (greater than 4) and buckle strength (greater than 22 kgf/cm²). Example 1 also exhibited suitable anti-folding characteristics measured by folding the cable ties to determined if breakage occured along the fold line.

The injection molding characteristics of Example 1 were then compared to various Comparative Examples, which represent commercially available polyamide-6 compositions, all at a molding temperature of 285° C. The results are set forth in Example 6.

TABLE 6

| Example | 1 | A | B | C | M | N |
|---|---|---|---|---|---|---|
| Injection | 950 | 950 | 950 | 1300 | 1350 | 1400 |
| pressure | | | | | | |
| (kgf/cm²) | | | | | | |
| Mold release | 4.3 | 2 | 3.7 | 3 | 3 | 2 |
| Buckle | 35.05 | 28.14 | 34.46 | 34.64 | 33.04 | 31.54 |
| strength | | | | | | |
| (conditioned) | | | | | | |

The results demonstrate that other commercially available polyamide-6 compositions have significantly lower mold release values than Example 1, and accordingly, would not be suitable for certain injection molding processes including processes for making cable ties.

Various modifications were then made to the composition of Example 1 to determine the effect on processing characteristics.

TABLE 7

Example

| | 1 | 2 | 3 | 4 |
|---|---|---|---|---|
| Injection pressure | 950 | 1400 | 1200 | 1150 |
| (kgf/cm²) | | | | |
| Mold release | 4.3 | 3.7 | 4.7 | 4.7 |
| Buckle strength | 35.05 | 34.21 | 38.03 | 38.26 |
| (conditioned) | | | | |

The results set forth above demonstrate that various embodiments of the present invention have a suitable mold release value for a variety of molding characteristics. However, Example 1, which is formed from a polyamide 6 material having a viscosity of less than 42 FAV still exhibited a low injection pressure.

From the foregoing description, one skilled in the art can easily ascertain the essential characteristics of this invention and, without departing from the spirit and scope thereof, can make various changes and modifications of the invention to adapt it to various usages and conditions.

1. A cable tie comprising:
an elongate polymer body comprising a polyamide composition, wherein the polyamide composition comprises at least one polyamide-6 material and at least one nucleating agent dispersed within the polyamide material, the at least one nucleating agent comprising at least one organic material and at least one inorganic metallic material.

2. The cable tie of claim 1 further comprising gear teeth disposed near a first end of the elongate polymer body and a ratchet disposed near a second end of the elongate polymer body, wherein the ratchet is adapted to receive and fasten to the gear teeth.

3. The cable tie of claim 1, wherein the viscosity of the polyamide-6 is less than about 52 FAV.

4. The cable tie of claim 1, wherein the viscosity of the polyamide-6 is between about 30 and about 42 FAV.

5. The cable tie of claim 1, wherein the organic material comprises a polymer.

6. The cable tie of claim 1, wherein the organic material comprises a polyamide material having a ratio of carbon atoms to amide groups of less than 5:1.

7. The cable tie of claim 1, wherein the organic material comprises a polyamide material having a ratio of carbon atoms to amide groups of no more than 2:1.

8. The cable tie of claim 1, wherein the organic material comprises polyamide-22.

9. The cable tie of claim 1, wherein the organic material comprises at least about 50 wt % of the nucleating agent.

10. The cable tie of claim 1, wherein the organic polymer comprises at least about 75 wt % of the nucleating agent.

11. The cable tie of claim 1, wherein the at least one inorganic metallic material comprises a metal oxide, a silicon dioxide or a derivative or combination thereof.

12. The cable tie of claim 1, wherein the at least one inorganic metallic material comprises aluminum oxide, silicon dioxide or a derivative thereof.

13. The cable tie of claim 1, wherein the at least one inorganic metallic material comprises a metal silicate.

14. The cable tie of claim 1, wherein the at least one inorganic metallic material comprises alumina silicate.

15. The cable tie of claim 1, wherein the nucleating agent is comprised of less than about 25 wt % alumina silicate.

16. The cable tie of claim 1, wherein the nucleating agent is comprised of a polyamide material having a ratio of carbon atoms to amide groups of less than 5:1 and a metal oxide, metal silicate or both.

17. The cable tie of claim 1, wherein the polyamide composition comprises less than 0.5 wt % nucleating agent.

18. The cable tie of claim 1, wherein the polyamide composition further comprises at least one polyamide-66 material.

19. The cable tie of claim 1, further comprising at least one lubricating agent comprising at least one stearate, stearamide, polysiloxan, polyolefin, ethylenevinylacetate copolymer or combination thereof.

20. The cable tie of claim 19 wherein the lubricating agent selected from the group consisting of ethylene-bis-stearamide, zinc stearate, magnesium stearate, calcium stearate, sodium stearate, polydimethylsiloxane, polyolefin, and ethylenevinylacetate copolymers.

21. The cable tie of claim 19, wherein the at least one lubricating agent is one or both of a stearamide and a stearate.

22. The cable tie of claim 19, wherein the at least one lubricating agent is one or both of ethylene-bis-stearamide and zinc stearate.

23. A method for forming a cable tie comprising:
melting a polyamide composition comprising at least one polyamide-6 material, and at least one nucleating agent, the nucleating agent comprising at least one inorganic metallic material and at least one organic material;
injecting the melted polyamide composition into a mold;
cooling the mold to form a cable tie; and
releasing the cable tie from the mold.

24. The method of claim 23 wherein the polyamide composition is melted at a temperature of less than 300° C.

25. The method of claim 23 wherein the polyamide composition is injected at a pressure of less than 1000 kgf/cm².

26. A polyamide composition comprising:
at least one polyamide-6 material having a viscosity of less than about 40 FAV;
less than about 2.0 wt % of at least one nucleating agent dispersed within the polyamide material, the at least one nucleating agent comprising at least about 50 wt % organic polymer and less than about 50 wt % inorganic metallic material; and
at least one lubricating agent.

27. The polyamide composition of claim 26, wherein the viscosity of the polyamide-6 is between 30 and 42 FAV.

28. The polyamide composition of claim 26, wherein the organic polymer comprises a polyamide having a ratio of carbon atoms to amide groups of less than 5:1.

29. The polyamide composition of claim 26, wherein the at least one lubricating agent is one or both of a stearamide and a stearate.

30. The polyamide composition of claim 26, wherein the lubricating agent comprises ethylene-bis-stearamide, zinc stearate or both.

31. The polyamide composition of claim 26, wherein the at least one inorganic metallic material comprises a metal silicate.

32. The polyamide composition of claim 26, wherein the at least one inorganic metallic material comprises alumina silicate.

33. The polyamide composition of claim 26, wherein the nucleating agent comprises less than about 25 wt % of the at least one inorganic metallic material.
